(19) United States
(12) Patent Application Publication
(10) Pub. No.: US 2015/0213788 A1
(43) Pub. Date: Jul. 30, 2015

(54) Guitar Bridge Pin Anchor

(71) Applicant: Hankscraft Inc., Reedsburg, WI (US)

(72) Inventor: David M. Heuss, Lake Mills, WI (US)

(21) Appl. No.: 14/166,400

(22) Filed: Jan. 28, 2014

(51) Int. Cl. G10D 3/12

(52) U.S. Cl. CPC G10D 3/12

(57) ABSTRACT

An apparatus for securing one end of a guitar string to a guitar is disclosed. The apparatus includes a mount adapted to be secured to and extend upwardly from the bridge of the guitar. The apparatus also can include a string holder connected to the mount, the string holder comprising an anchor portion for securely holding the end of the guitar string, the string holder having a first end portion and a second end portion, the first end portion positioning the guitar string below a saddle height of the bridge, and a position adjuster operatively connected to the mount and the string holder, the position adjuster adjusting the pivot angle of the string holder to adjust tension on the guitar string.

### BACKGROUND

Guitar strings must be secured to a guitar on two ends. At the end of the guitar neck, tuning pegs serve as one anchor point. At the opposite end, in guitars such as acoustic guitars, the guitar string passes over a saddle supported by the bridge and is secured by a pin that forms an interference fit in a hole in the bridge.

Most electric guitars, in contrast, do not employ a hole and pin method of securing a guitar string to a guitar. Instead, the ball end of the guitar string is held in place by u-shaped stoppers aligned on the bridge.

It is with respect to this general environment that the embodiments of the present application are directed.

### SUMMARY

In summary, the present disclosure relates to an apparatus for securing one end of a guitar string at the bridge of a guitar. In a first aspect, the apparatus for securing one end of a guitar string on the end opposite the headstock includes a mount adapted to be secured to and extend upwardly from the guitar, and where the mount defines a cavity for securing the ball end of the guitar.

### BRIEF DESCRIPTION OF THE DRAWINGS

FIG. 1 is a side view illustrating a string anchor system according to an another example embodiment of the present disclosure;

FIG. 2A is a top view of a head of the example embodiment depicted in FIG. 10;

FIG. 2B is a side view of a head of the example embodiment depicted in FIG. 10.

### DETAILED DESCRIPTION

As briefly described above, embodiments of the present invention are directed to securing a guitar string to a guitar. Known securing means have multiple deficiencies. For instance, the pegs used to secure the string in the bridge hole can be tapered and difficult to extract. The pegs can be particularly difficult to extract when the pegs have been driven into the bridge with a lot of force. Also, the pegs can pop out of the hole if not properly secured. When the peg pops out of the hole, the string loses tension and the guitar can become unplayable. This is unacceptable, especially during a live performance. Additionally, the pegs can break when they are being removed from the bridge holes. This can leave part of the peg stuck in the bridge hole, which can be difficult to remove safely and without damaging the guitar. Another problem with current peg-in-hole systems is that no standard bridge hole exists, which complicates the replacement process when a peg breaks or is lost. Thus, finding an appropriately sized peg can be a challenge and if the peg is too small, it can fall out, but if the peg is too large it will not push all the way into the bridge. Still another problem with existing securing means is that changing a guitar string can be time consuming and awkward. Again, this is unacceptable during a live performance.

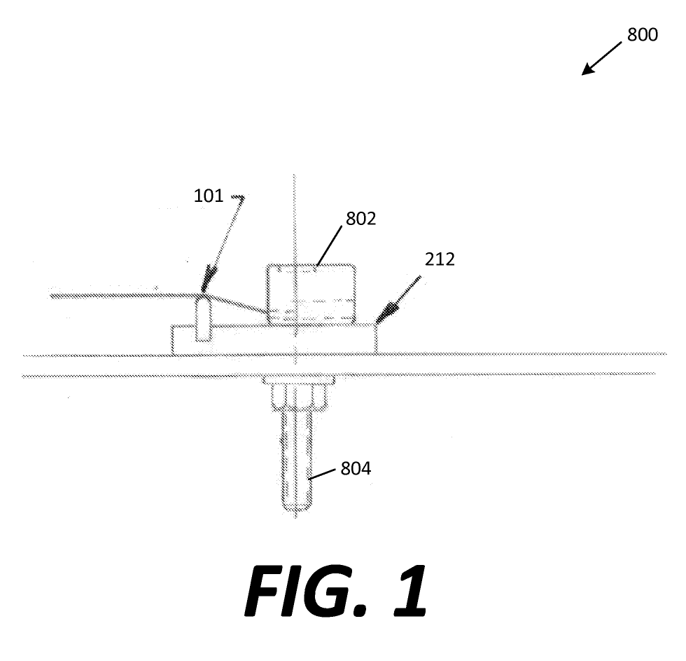

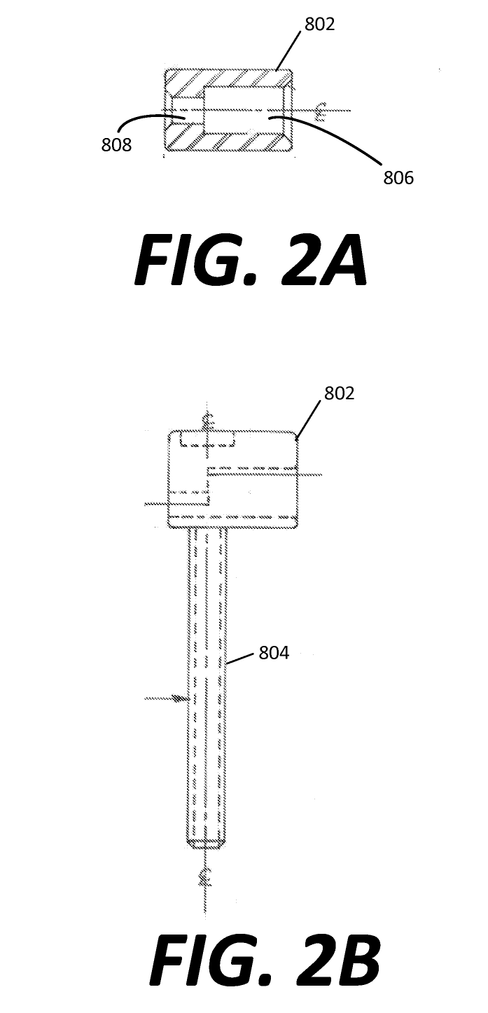

FIGS. 1, 2A and 2B depict an embodiment of a guitar string anchor system 800. The string anchor system embodiment 800 has an extension and fastening elements 804. Embodiment 800 has a single head 802 that is integral or attached to extension 804.

As shown in FIG. 2A, head 802 has a receiving cavity 806 that is configured to hold the ball end 103 of a guitar string. Head 802 has a channel 808 for the guitar string to pass through, where the channel 808 is substantially cylindrical or a prism in shape. As shown in FIGS. 1, 2A and 2B, head 802 is substantially shaped as a rectangular prism. Other configurations are possible, provided the head portion 802 does not rock back and forth while the guitar is being played.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. An apparatus for securing one end of a guitar string on a guitar on an opposing end from the headstock, the apparatus comprising:
a mount adapted to be secured to and extend upwardly from the guitar;
a string holder connected to the mount, the string holder comprising an anchor portion for securely holding the end of the guitar string, the string holder having a first end portion and a second end portion, the first end portion positioning the guitar string below a saddle height of the bridge; and
a position adjuster operatively connected to the mount and the string holder, the position adjuster adjusting the pivot angle of the string holder to adjust tension on the guitar string.
